(19) United States
(12) Patent Application Publication
(10) Pub. No.: US 2022/0112815 A1
(43) Pub. Date: Apr. 14, 2022

(54) ABRADABLE SEAL STRUCTURE FOR GAS TURBINE FORMED USING BINDER JETTING

(71) Applicant: General Electric Company, Schenectady, NY (US)

(72) Inventors: Surinder Singh Pabla, Greer, SC (US); Srikanth Chandrudu Kottilingam, Greenville, SC (US)

(21) Appl. No.: 17/069,061

(22) Filed: Oct. 13, 2020

(51) Int. Cl. F01D 11/12; B33Y 80/00

(52) U.S. Cl. CPC F01D 11/122; B33Y 80/00; B33Y 10/00; F05D 2230/22; F05D 2240/55; F05D 2220/32

(57) ABSTRACT

An abradable seal structure for a gas turbine is formed using binder jetting. The structure may include a first plurality of adjoining cells and a second plurality of adjoining cells. The first plurality of adjoining cells has at least one of a different size, shape, wall thickness, and configuration of adjoining cells than the second plurality of adjoining cells. The abradable seal structure may also have varying porosity across an area thereof.

### TECHNICAL FIELD

The disclosure relates generally to hot gas path sealing in gas turbines, and more particularly, to an abradable seal structure for a gas turbine made using binder jetting.

### BACKGROUND

Combustion or gas turbine engines (hereinafter “gas turbines”) include compressor and turbine sections in which rows of blades are axially stacked in stages. Each stage typically includes a row of circumferentially-spaced stator blades, which are fixed, and a row of rotor blades, which rotate about a central turbine axis or shaft. In operation, the compressor rotor blades are rotated about the shaft, and, acting in concert with the stator blades, compress a flow of air. This supply of compressed air is used within a combustor to combust a supply of fuel. The resulting flow of hot expanding combustion gases, which is often referred to as working fluid, is then expanded through the turbine section of the engine, wherein it is redirected by the stator blades onto the rotor blades so to induce rotation. The rotor blades are connected to a central shaft such that the rotation of the rotor blades rotates the shaft. In this manner, the energy contained in the fuel is converted into the mechanical energy of the rotating shaft, which, for example, may be used to rotate the rotor blades of the compressor, so to produce the supply of compressed air needed for combustion, as well as, for example, the coils of a generator so to generate electrical power. During operation, however, leakage across the rows of turbine blades negatively affects engine efficiency.

Many industrial applications, such as those involving power generation and aviation, still rely heavily on gas turbines, and because of this, the engineering of more efficient engines remains an ongoing and important objective. As will be appreciated, even incremental advances in machine performance, efficiency, or cost-effectiveness are meaningful in the highly competitive markets that have evolved around this technology. While there are several known strategies for improving the efficiency of gas turbines, such as, for example, increasing the size of the engine, firing temperatures, or rotational velocities, each of these generally places additional strain on those already highly stressed hot-gas path components. Another manner by which gas turbine engine efficiency may be enhanced is through improved sealing technology, in particular relating to the seals formed within the gaps defined between stationary and rotating structure within the gas turbine. As will be appreciated, during operation, working fluid that flows between the outer radial tip of the rotor blade and the surrounding stationary structure represents leakage that negatively impacts efficiency. The current approach to improve sealing is to use blades that are unshrouded, which places a greater impetus on controlling clearance between the blades and the casing. Abradable coatings are used on the casing or on casing-shroud segments to control clearance and reduce damage to the blades. Other systems use abradable honeycomb structures that rub against rails in shrouded blades made from, e.g., nickel chromium alloys. The honeycomb structure has an oxidation resistance and a wall thickness that has sufficient oxidation resistance to survive the operating temperatures. Aluminizing the honeycomb structure provides a significant increase in oxidation resistance and makes the wall significantly more brittle, which improves the abradability of the alloy.

Manufacture of the honeycomb structures presents a number of limitations. One current manufacturing technique stamps sheet metal into the desired shape and tack welds the parts together to form the honeycomb structure. The materials that can be stamped in this manner oftentimes do not provide the desired porosity, brittleness and abradability. In addition, the arrangement of the honeycomb structure is limited by the ability to stamp the material and connect the parts together. In order to address the shortcomings, current approaches may employ complex heat treatments and aluminizing processes, which oftentimes still do not provide the desired operational characteristics. Another manufacturing approach laser dads abradable material onto the desired surface or forms the honeycomb structure using direct metal laser manufacturing (DMLM). These latter approaches require the material to be weldable, which limits the materials that can be used and the operational characteristics that are attainable.

### BRIEF DESCRIPTION

A first aspect of the disclosure provides a method of forming an abradable seal structure for a gas turbine, the method comprising: forming a preliminary abradable seal structure using a binder jetting process, the preliminary abradable seal structure including a plurality of adjoining cells; and sintering the preliminary abradable seal structure, the sintering selectively controlled to create a desired porosity of the abradable seal structure.

A second aspect of the disclosure provides an abradable seal structure for a gas turbine, the structure comprising: a first plurality of adjoining cells and a second plurality of adjoining cells, the first plurality of adjoining cells having at least one of a different size, shape, wall thickness and configuration of adjoining cells than the second plurality of adjoining cells, wherein the first and second plurality of adjoining cells are formed by binder jetting.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a schematic representation of an illustrative gas turbine that may include turbine blades according to embodiments of the disclosure;

FIG. 2 is a sectional view of the compressor section of the gas turbine of FIG. 1;

FIG. 3 is a sectional view of the turbine section of the gas turbine of FIG. 1;

FIG. 4 is a perspective view of an illustrative turbine rotor blade having a conventional tip shroud;

FIG. 5 is a side view of an illustrated seal formed between the outer radial tip of a shrouded turbine rotor blade and the stationary structure that surrounds it;

FIG. 6 is a perspective view of an illustrative abradable seal structure of a seal in accordance with embodiments of the disclosure;

FIG. 7 shows a block diagram of an additive manufacturing system and process in the form of a binder jetting system and including a non-transitory computer readable storage medium storing code representative of a component according to embodiments of the disclosure;

FIG. 8 shows a plan view of an abradable seal structure, according to embodiments of the disclosure;

FIG. 9 shows a plan view of an abradable seal structure, according to other embodiments of the disclosure;

FIG. 10 shows a plan view of an abradable seal structure, according to additional embodiments of the disclosure; and

FIG. 11 shows a plan view of an abradable seal structure, according to yet other embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

Aspects and advantages of the present application are set forth below in the following description, or may be obvious from the description, or may be learned through practice of the disclosure. Reference will now be made in detail to present embodiments of the disclosure, one or more examples of which are illustrated in the accompanying drawings. The detailed description uses numerical designations to refer to features in the drawings. As will be appreciated, each example is provided by way of explanation of the disclosure, not limitation of the disclosure. In fact, it will be apparent to those skilled in the art that modifications and variations can be made in the present disclosure without departing from the scope or spirit thereof. For instance, features illustrated or described as part of one embodiment may be used on another embodiment to yield a still further embodiment. It is intended that the present disclosure covers such modifications and variations as come within the scope of the appended claims and their equivalents. It is to be understood that the ranges and limits mentioned herein include all sub-ranges located within the prescribed limits, inclusive of the limits themselves unless otherwise stated. Additionally, certain terms have been selected to describe the present disclosure and its component subsystems and parts. To the extent possible, these terms have been chosen based on the terminology common to the technology field. Still it will be appreciate that such terms often are subject to differing interpretations. For example, what may be referred to herein as a single component, may be referenced elsewhere as consisting of multiple components, or, what may be referenced herein as including multiple components, may be referred to elsewhere as being a single component. Thus, in understanding the scope of the present disclosure, attention should not only be paid to the particular terminology used, but also to the accompanying description and context, as well as the structure, configuration, function, and/or usage of the component being referenced and described, including the manner in which the term relates to the several figures, as well as, the precise usage of the terminology in the appended claims. Further, while the following examples are presented in relation to certain types of gas turbines or turbine engines, the technology of the present application also may be applicable to other categories of turbine engines, without limitation, as would the understood by a person of ordinary skill in the relevant technological arts. Accordingly, it should be understood that unless otherwise stated, the usage herein of the term “gas turbine” is intended broadly and with limitation as the applicability of the present disclosure to the various types of turbine engines.

Given the nature of how gas turbines operate, several terms prove particularly useful in describing certain aspects of their function. As will be understood, these terms may be used both in describing or claiming the gas turbine or one of the subsystems thereof, e.g., the compressor, combustor, or turbine, as well as to describe or claim components or subcomponents for usage therewithin. In the latter case, the terminology should be understood as describing those components as they would be upon proper installation and/or function within the gas turbine engine or primary subsystem. These terms and their definitions, unless specifically stated otherwise, are as follows.

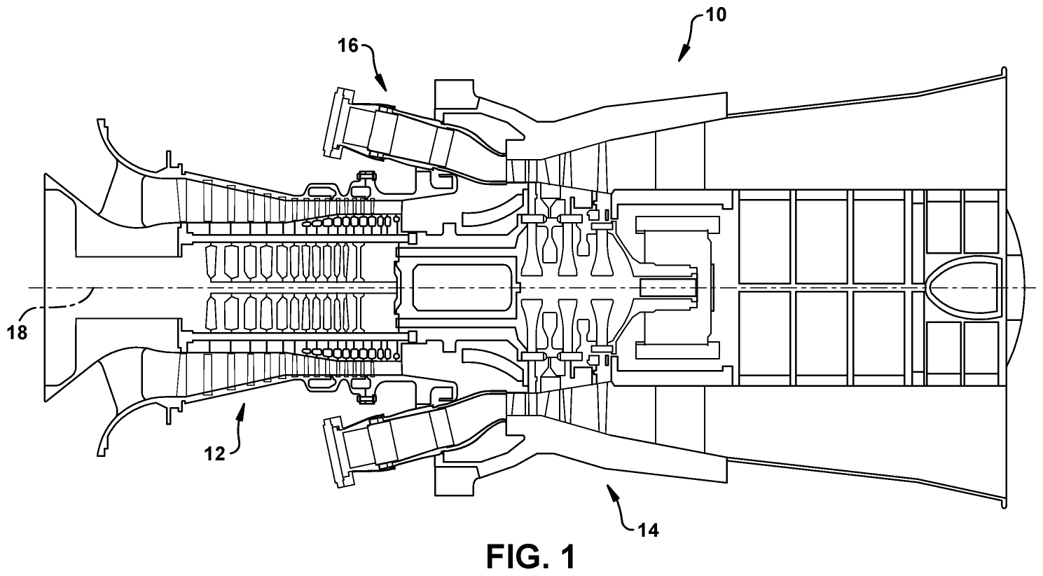

The terms “forward” and “aft” refer to directions relative to the orientation of the gas turbine and, more specifically, the relative positioning of the compressor and turbine sections of the engine. Thus, as used therein, the term “forward” refers to the compressor end while “aft” refers to the turbine end. It will be appreciated that each of these terms may be used to indicate direction of movement or relative position along the central axis of the engine. As stated above, these terms may be used to describe attributes of the gas turbine or one of its primary subsystems, as well as for components or subcomponents positioned therewithin. Thus, for example, when a component, such as a rotor blade, is described or claimed as having a “forward face”, it may be understood as referring to a face that faces toward the forward direction as defined by the orientation of the gas turbine (i.e., the compressor being designated as the forward end and turbine being designated as the aft end). To take a major subsystem like the turbine as another example (and assuming a typical gas turbine arrangement such as the one shown in FIG. 1), the forward and aft directions may be defined relative to a forward end of the turbine, at where a working fluid enters the turbine, and an aft end of the turbine, at where the working fluid exits the turbine.

The terms “downstream” and “upstream” are used herein to indicate position within a specified conduit or flowpath relative to the direction of flow (hereinafter “flow direction”) moving through it. Thus, the term “downstream” refers to the direction in which a fluid is flowing through the specified conduit, while “upstream” refers to the direction opposite that. These terms may be construed as referring to the flow direction through the conduit given normal or anticipated operation. As will be appreciated, within the compressor and turbine sections of the gas turbine, the working fluid is directed downstream and through an annularly shaped working fluid flowpath, which is typically defined about the central and common axis of the gas engine. As such, within the compressor and turbine sections of the engine, the term “flow direction”, as used herein, refers to a reference direction representing an idealized direction of flow of working fluid through the working fluid flowpath of the engine during an expected or normal condition of operation. Thus, within the compressor and turbine sections, the “flow direction” terminology is referring to flow that is parallel to the central axis of the gas turbine and oriented in the downstream or aft direction.

Thus, for example, the flow of working fluid through the working fluid flowpath of the gas turbine may be described as beginning as air pressurized through the compressor per the flow direction, becoming combustion gases in the combustor upon being combusted with a fuel, and, finally, being expanded per the flow direction as it passed through the turbine. Likewise, the flow of working fluid may be described as beginning at a forward or upstream location toward a forward or upstream end of the gas turbine, moving generally in a downstream or aft direction, and, finally, terminating at an aft or downstream location toward an aft or downstream end of the gas turbine.

Given the configuration of gas turbines, particularly the arrangement of the compressor and turbine sections about a common shaft or rotor, as well as the cylindrical configuration common to many combustor types, terms describing position relative to an axis may be regularly used herein. In this regard, it will be appreciated that the term “radial” refers to movement or position perpendicular to an axis. Related to this, it may be required to describe relative distance from the central axis. In such cases, for example, if a first component resides closer to the central axis than a second component, the first component will be described as being either “radially inward” or “inboard” of the second component. If, on the other hand, the first component resides further from the central axis, the first component will be described as being either “radially outward” or “outboard” of the second component. As used herein, the term “axial” refers to movement or position parallel to an axis, while the term “circumferential” refers to movement or position around an axis. Unless otherwise stated or plainly contextually apparent, these terms should be construed as relating to the central axis of the compressor and/or turbine sections of the gas turbine as defined by the rotor extending through each, even if the terms are describing or claiming attributes of non-integral components—such as rotor or stator blades—that function therein.

The term “rotor blade”, without further specificity, is a reference to the rotating blades of either the compressor or the turbine, and so may include both compressor rotor blades and turbine rotor blades. The term “stator blade”, without further specificity, is a reference to the stationary blades of either the compressor or the turbine and so may include both compressor stator blades and turbine stator blades. The term “blades” may be used to generally refer to either type of blade. Thus, without further specificity, the term “blades” is inclusive to all type of turbine engine blades, including compressor rotor blades, compressor stator blades, turbine rotor blades, turbine stator blades and the like.

In addition, several descriptive terms may be used regularly herein, as described below. The terms “first”, “second”, and “third” may be used interchangeably to distinguish one component from another and are not intended to signify location or importance of the individual components.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof “Optional” or “optionally” means that the subsequently described event or circumstance may or may not occur or that the subsequently describe component or element may or may not be present, and that the description includes instances where the event occurs or the component is present and instances where it does not or is not present.

Where an element or layer is referred to as being “on,” “engaged to,” “connected to” or “coupled to” another element or layer, it may be directly on, engaged to, connected to, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

By way of background, referring now with specificity to the figures, FIGS. 1-3 illustrate an illustrative gas turbine in accordance with the present disclosure or within which the present disclosure may be used. It will be understood by those skilled in the art that the present disclosure may not be limited to this type of usage. As stated, the present disclosure may be used in gas turbines, such as the engines used in power generation and airplanes, steam turbine engines, as well as other types of rotary engines as would be recognized by one of ordinary skill in the art. The examples provided are not meant to be limiting unless otherwise stated. FIG. 1 is a schematic representation of a gas turbine 10. In general, gas turbines operate by extracting energy from a pressurized flow of hot gas produced by the combustion of a fuel in a stream of compressed air. As illustrated in FIG. 1, gas turbine 10 may be configured with an axial compressor 12 that is mechanically coupled by a common shaft or rotor to a downstream turbine section or turbine 14, and a combustor 16 positioned between compressor 12 and turbine 14. As illustrated in FIG. 1, gas turbine 10 may be formed about a common central axis 18.

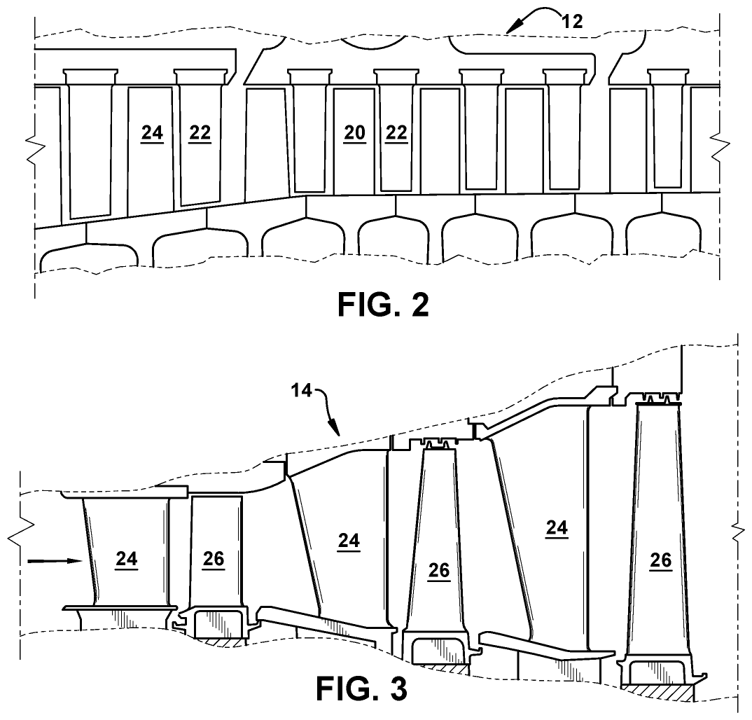

FIG. 2 illustrates a view of an illustrative multi-staged axial compressor 12 that may be used in the gas turbine of FIG. 1. As shown, compressor 12 may have a plurality of stages, each of which include a row of compressor rotor blades 20 and a row of compressor stator blades 22. Thus, a first stage may include a row of compressor rotor blades 20, which rotate about a central shaft, followed by a row of compressor stator blades 22, which remain stationary during operation. FIG. 3 illustrates a partial view of an illustrative turbine section or turbine 14 that may be used in gas turbine 10 of FIG. 1. Turbine 14 also may include a plurality of stages. Three illustrative stages are shown, but more or less may be present. Each stage may include a plurality of turbine nozzles or stator blades 24, which remain stationary during operation, followed by a plurality of turbine buckets or rotor blades 26, which rotate about the shaft during operation. Turbine stator blades 24 generally are circumferentially spaced one from the other and fixed about the axis of rotation to an outer casing. Turbine rotor blades 26 may be mounted on a turbine wheel or rotor disc (not shown) for rotation about a central axis. It will be appreciated that turbine stator blades 24 and turbine rotor blades 26 lie in the hot gas path or working fluid flowpath through turbine 14. The direction of flow of the combustion gases or working fluid within the working fluid flowpath is indicated by the arrow.

In one example of operation for gas turbine 10, the rotation of compressor rotor blades 20 within axial compressor 12 may compress a flow of air. In combustor 16, energy may be released when the compressed air is mixed with a fuel and ignited. The resulting flow of hot gases or working fluid from combustor 12 is then directed over turbine rotor blades 26, which induces the rotation of turbine rotor blades 26 about the shaft. In this way, the energy of the flow of working fluid is transformed into the mechanical energy of the rotating blades and, given the connection between the rotor blades and the shaft, the rotating shaft. The mechanical energy of the shaft may then be used to drive the rotation of compressor rotor blades 20, such that the necessary supply of compressed air is produced, and/or, for example, a generator to produce electricity.

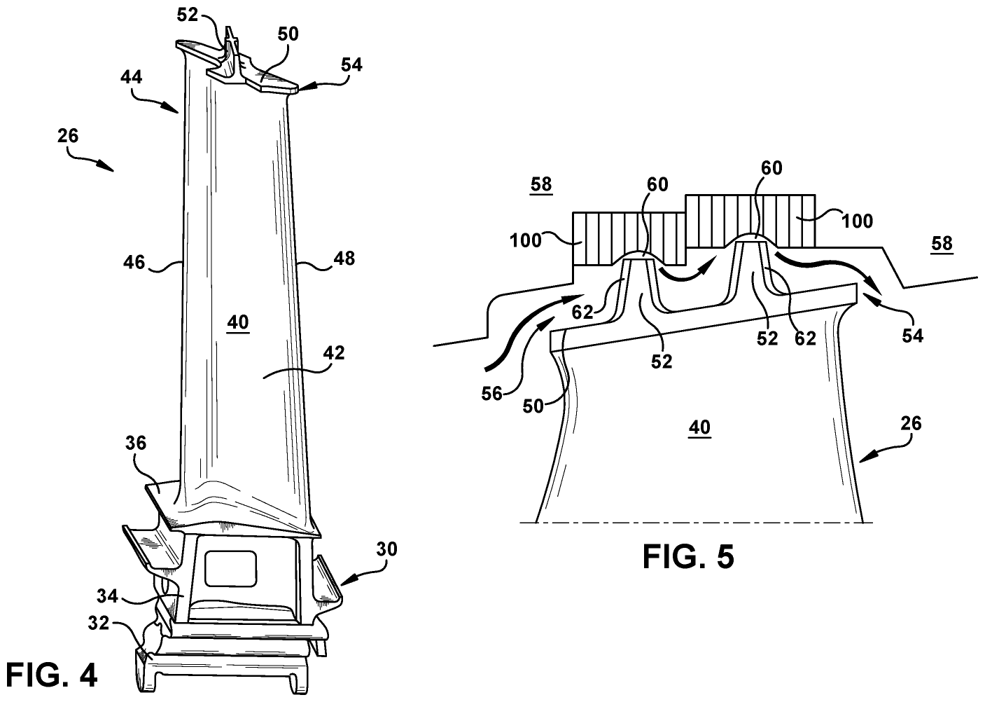

For background purposes, FIG. 4 provides a perspective view of a conventional shrouded turbine rotor blade 26 and related sealing structures. It is noted that the teachings of the disclosure are also applicable to unshrouded blades also. Rotor blade 26 may include a root 30 that is configured for attaching to a rotor disc. Root 30, for example, may include a dovetail 32 configured for mounting in a corresponding dovetail slot in the perimeter of a rotor disc. Root 30 may further include a shank 34 that extends between dovetail 32 and a platform 36. Platform 36, as shown, generally forms the junction between root 30 and an airfoil 40, with the airfoil being the active component of rotor blade 26 that intercepts the flow of working fluid through turbine 14 and induces the desired rotation. Platform 36 may define the inboard end of airfoil 40. Platform 36 also may define a section of the inboard boundary of the working fluid flowpath through turbine 14.

Airfoil 40 of the rotor blade typically includes a concave pressure face 42 and a circumferentially or laterally opposite convex suction face 44. Pressure face 42 and suction face 44 may extend axially between opposite leading and trailing edges 46, 48, respectively, and, in the radial direction, between an inboard end, which may be defined at the junction with platform 36, and an outboard tip, which may include a tip shroud 54. Airfoil 40 may include a curved or contoured shape that is designed for promoting desired aerodynamic performance. Rotor blade 26 may further include an internal cooling configuration having one or more cooling channels through which a coolant is circulated during operation. Such cooling channels may extend radially outward from a connection to a supply source formed through root 30 of rotor blade 26. Cooling channels may be linear, curved or a combination thereof, and may include one or more outlet or surface ports through which coolant is exhausted from the rotor blade 26 and into the working fluid flowpath.

As used herein, rotor blade 26 and components thereof may be described according to orientation characteristics of turbine 14. It should be appreciated that, in such cases, rotor blade 26 is assumed to be properly installed within turbine 14. Such orientation characteristics may include radial, axial, and circumferential directions defined relative to central axis 18 of turbine 14. Forward and aft directions may be defined relative to a forward end of turbine 14, at where the working fluid enters turbine 14 from combustor 16, and an aft end of turbine 14, at where the working fluid exits turbine 14. A rotation direction may be defined relative to an expected direction of rotation of rotor blade 26 about central axis 18 of turbine 14 during operation.

As shown in FIG. 5, according to these orientation characteristics, a seal rail 52 (two shown in this example) may be described as projecting from an outboard surface 50 of a tip shroud 54 along an axis approximately aligned with the radial direction to define a height. Seal rail 52 may extend along an axis approximately aligned with the circumferential direction to define a length. As illustrated, relative to the length, seal rail 52 may have a narrow thickness that extends along an axis approximately aligned with the axial direction.

With further reference to FIG. 5, as will be appreciated, seals are used throughout gas turbines to limit leakage through the gaps that necessarily occur between rotating and stationary structure. As this leakage negatively affects engine efficiency, the effectiveness of these seals is a significant consideration. As shown in FIG. 5, one such seal is shown, a seal 56, which may be used to deter over the tip leakage across a stage or row of rotor blades. As illustrated, seal 56 may include seal rail(s) 52 that extends radially from tip shroud 54 of a rotor blade 26. In this manner, seal rail(s) 52 narrows the distance between rotor blade 26 and stationary structure 58 that surrounds rotor blade 26, and, thereby, narrows radial gap 60 that occurs there. As further shown, seal 56 may utilize seal rail 52 in conjunction with a stationary abradable shroud or structure (hereinafter “abradable seal structure”) 100 that attaches to stationary structure 58. In this way, seal 56 forms an interface between seal rail(s) 52 of rotor blade 26 and abradable seal structure 100 so to further narrow the distance between the rotating and stationary structure in this region. As indicated, abradable seal structure 100 may be positioned so to directly oppose and axially align with the tip shroud 54 across radial gap 60, formed therebetween. As will be appreciated, in operation, thermal expansion within the engine generally causes relative movement between stationary and rotating structures so that seal rail(s) 52 moves radially so that, as indicated, seal rail(s) 52 cuts into abradable seal structure 100 and, thereby, further restricts the leakage path through radial gap 60. In this manner, abradable seal structure 100 enhances seal stability and further limits leakage. Although not necessary in all instances, the use of a cutter tooth 62 on seal rail(s) 52 may reduce rubbing between stationary and rotating parts by initially clearing a wider path through abradable seal structure 100. Cutter tooth 62 thus cuts a groove in abradable seal structure 100 that is slightly wider than the width of a seal rail 52.

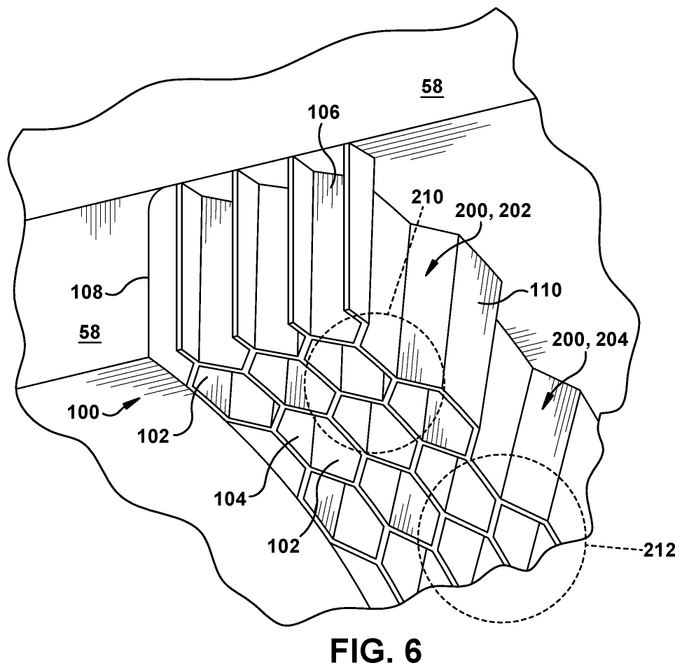

With reference now to both FIGS. 5 and 6, a perspective view of an illustrative abradable seal structure 100 is provided in FIG. 6 that should prove useful in describing certain aspects of the abradable seal structure 100. As will be appreciated, because it is meant to be worn away by seal rail(s) 52 without damaging rotor blade 26, abradable seal structure 100 typically is mostly hollow. To achieve this, abradable seal structure 100 typically is made up of a repeating pattern of a plurality of adjoining cells 102 (hereinafter “cells 102”) that are thin-walled. As described more below, these cells 102 may be arranged parallel to each other and oriented such that each extends across the radial thickness of abradable seal structure 100 so that each cell connects openings formed on the opposing outer surfaces of abradable seal structure 100.

The outer surfaces of abradable seal structure 100 may be defined according to their particular orientation in relation to the working fluid flowpath and/or the row of rotor blades. For example, as used herein, abradable seal structure 100 is defined as including an inboard outer surface 104 and an outboard outer surface 106. As indicated, inboard outer surface 104 of abradable seal structure 100 is the outer surface that directly opposes the row of rotor blades across radial gap 60, whereas outboard outer surface 106 of abradable seal structure 100 is the outer surface that faces stationary structure 58 and attaches thereto. Abradable seal structure 100 may be further defined as having a forward outer surface 108 and an aft outer surface 110. As indicated in the figures, forward outer surface 108 is the outer surface that extends between inboard outer surface 104 and outboard outer surface 106 at a forward end of abradable seal structure 100. Aft outer surface 110, in this case, is the outer surface that extends between inboard outer surface 104 and outboard outer surface 106 at an aft end of abradable seal structure 100.

As already stated, abradable seal structure 100 may be one that is made up of cells 102 that are separated from neighboring cells 102 by thin continuous walls. As shown, such cells 102 may be arranged parallel to each other and oriented such that each extends between an opening formed on inboard outer surface 104 and an opening formed on outboard outer surface 106 of abradable seal structure 100. In one embodiment, cells 102 may maintain a substantially constant cross-sectional shape between the openings formed on inboard and outboard outer surface 104, 106 of the abradable seal structure 100. This cross-sectional shape may take many forms, including rectangular, triangular, circular, and hexagonal, with the hexagonal “honeycomb” shape being one that is particularly common and functional.

As indicated, because of manufacturing and material limitations, abradable seal structure 100 of the configuration described above, is made of a material that must either be weldable (if formed by laser cladding or DMLM), or capable of being stamped into shape and welded together. In accordance with embodiments of the disclosure, abradable seal structure 100 is made using binder jetting.

Binder jetting is an additive manufacturing process, or three-dimensional (3D) printing process, that uses a liquid binding agent deposited onto a build platform to bond layers of powder material and create a part. Binder jetting can be used with a variety of materials that provide improved operational characteristics for abradable seal structure 100, including ceramics and metals, compared to conventional weldable or stampable materials.

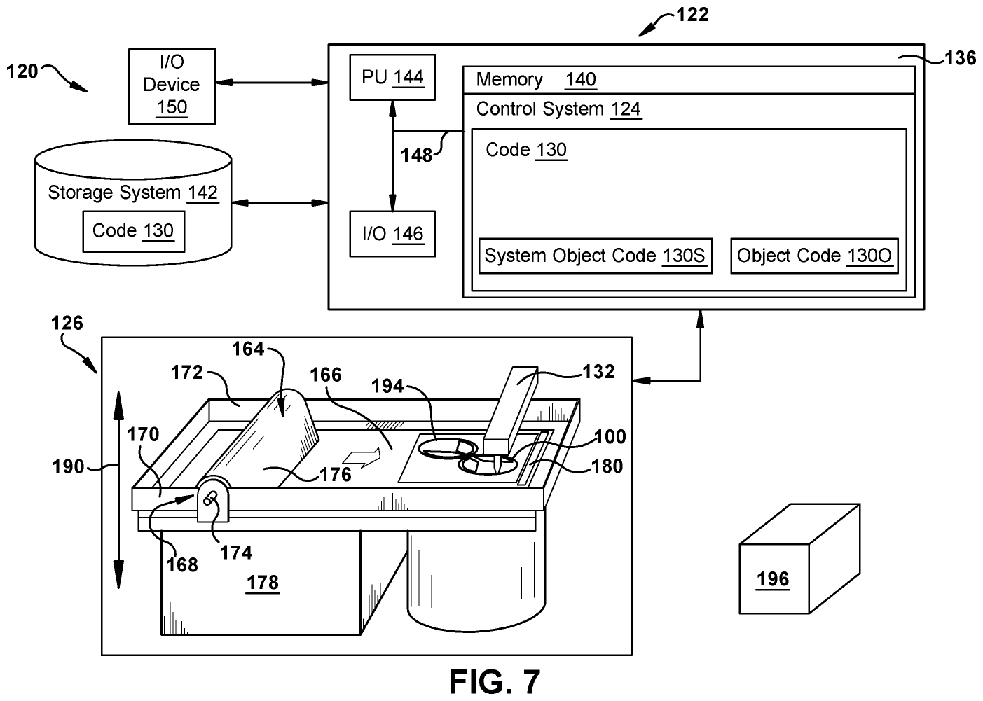

FIG. 7 shows a schematic/block view of an illustrative computerized binder jetting system 120 (hereinafter ‘BJ system 120’) for generating abradable seal structure 100. Multiple seal structures are shown being formed simultaneously, of which only a single layer is shown. The teachings of the disclosures will be described relative to building seal structure(s) 100 using a binder jet process. Seal structure(s) 100 are illustrated as rectangular elements; however, it is understood that the binder jetting process can be readily adapted to manufacture any shaped seal structure on a build platform 118.

BJ system 120 generally includes a control system 124 (“control system”) and a binder jet printer 126. As will be described, control system 122 executes object code 1300 to generate seal structure(s) 100 using a binding agent printhead 132. Control system 122 is shown implemented on computer 136 as computer program code. To this extent, computer 136 is shown including a memory 140 and/or storage system 142, a processor unit (PU) 144, an input/output (I/O) interface 146, and a bus 148. Further, computer 146 is shown in communication with an external I/O device/resource 150 and storage system 142. In general, processor unit (PU) 144 executes computer program code 130 that is stored in memory 140 and/or storage system 142. While executing computer program code 130, processor unit (PU) 144 can read and/or write data to/from memory 140, storage system 142, I/O device 144 and/or BJ printer 126. Bus 148 provides a communication link between each of the components in computer 136, and I/O device 150 can comprise any device that enables a user to interact with computer 136 (e.g., keyboard, pointing device, display, etc.). Computer 136 is only representative of various possible combinations of hardware and software. For example, processor unit (PU) 144 may comprise a single processing unit, or be distributed across one or more processing units in one or more locations, e.g., on a client and server. Similarly, memory 140 and/or storage system 142 may reside at one or more physical locations. Memory 140 and/or storage system 142 can comprise any combination of various types of non-transitory computer readable storage medium including magnetic media, optical media, random access memory (RAM), read only memory (ROM), etc. Computer 136 can comprise any type of computing device such as an industrial controller, a network server, a desktop computer, a laptop, a handheld device, etc.

As noted, BJ system 120 and, in particular control system 122, executes program code 130 to generate seal structure(s) 100. Program code 130 can include, inter alia, a set of computer-executable instructions (herein referred to as ‘system code 130S’) for operating BJ printer 126 or other system parts, and a set of computer-executable instructions (herein referred to as ‘object code 1300’) defining seal structure(s) 100 to be physically generated by BJ printer 126. As described herein, additive manufacturing processes begin with a non-transitory computer readable storage medium (e.g., memory 140, storage system 142, etc.) storing program code 130. System code 130S for operating BJ printer 126 may include any now known or later developed software code capable of operating BJ printer 126.

Object code 1300 defining seal structure(s) 100 may include a precisely defined 3D model of an object and can be generated from any of a large variety of well-known computer aided design (CAD) software systems such as AutoCAD®, TurboCAD®, DesignCAD 3D Max, etc. In this regard, object code 1300 can include any now known or later developed file format. Furthermore, object code 1300 representative of seal structure(s) 100 may be translated between different formats. For example, object code 1300 may include Standard Tessellation Language (STL) files which was created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional object to be fabricated on any BJ printer. Object code 1300 representative of seal structure(s) 100 may also be converted into a set of data signals and transmitted, received as a set of data signals and converted to code, stored, etc., as necessary. In any event, object code 1300 may be an input to BJ system 120 and may come from a part designer, an intellectual property (IP) provider, a design company, the operator or owner of BJ system 120, or from other sources. In any event, control system 122 executes system code 130S and object code 1300, dividing seal structure(s) 100 into a series of thin slices that assembles using BJ printer 126 in successive layers of material.

Continuing with FIG. 7, an applicator 164 may create a thin layer of raw material 166 spread out as the blank canvas from which each successive slice of the final object will be created. Applicator 164 may move under control of a linear transport system 168. Linear transport system 168 may include any now known or later developed arrangement for moving applicator 164. In one embodiment, linear transport system 168 may include a pair of opposing rails 170, 172 extending on opposing sides of build platform 118, and a linear actuator 174 such as an electric motor coupled to applicator 164 for moving it along rails 170, 172. Linear actuator 174 is controlled by control system 122 to move applicator 164. Other forms of linear transport systems may also be employed. Applicator 164 may take a variety of forms. In one embodiment, applicator 164 may include a body 176 configured to move along opposing rails 170, 172, and an actuator element (not shown in FIG. 7) in the form of a tip, blade or brush configured to spread metal powder evenly over build platform 118, i.e., build platform 118 or a previously formed layer of seal structure(s) 100, to create a layer of raw material. The actuator element may be coupled to body 176 using a holder (not shown) in any number of ways. The process may use different raw materials in the form of metal powder. Raw materials may be provided to applicator 164 in a number of ways. In one embodiment, shown in FIG. 7, a stock of raw material may be held in a raw material source 178 in the form of a chamber accessible by applicator 164. In other arrangements, raw material may be delivered through applicator 164, e.g., through body 176 in front of its applicator element and over build platform 118. In any event, an overflow chamber 180 may be provided on a far side of applicator 164 to capture any overflow of raw material not layered on build platform 118. In FIG. 7, only one applicator 164 is shown. In some embodiments, applicator 164 may be among a plurality of applicators in which applicator 164 is an active applicator and other replacement applicators (not shown) are stored for use with linear transport system 168. Used applicators (not shown) may also be stored after they are no longer usable.

In one embodiment, seal structure(s) 100 may be made of a metal or non-metallic material. For example, seal structure(s) 100 may include metal or metal alloys such as: ferrous metals like steel, stainless steel and other high alloy steels, or non-ferrous metals like a nickel-based alloy, a cobalt-based alloy, or titanium-based alloy. In another example, the material may include a ceramic including a zirconia-based composition. More particularly, the ceramic may include zirconia-based composition such as but not limited to: yttria-stabilized zirconia (8YSZ) or more advanced chemistries such as low thermal conductivity, high RE, low dielectric constant (low-K) materials and ultra-low K materials which are fully phase stable at elevated temperatures while offer reductions in thermal conductive due to phonon scattering. Ultra-low K materials may include ytterbium-zirconium (Yb—Zr) oxide combinations with 45-65 weight percent (wt %) ytterbium (III) oxide (Yb₂O₃) with the balance of zirconia (zirconium oxide (ZrO₂)); 45-65 weight percent (wt %) ytterbium, yttrium, hafnium, lanthanum (Yb/Y/Hf/La) with the balance of zirconia; or 2.3-7.8 wt % La, 1.4-5.1% Y and the balance zirconia. Compositions of fully stabilized zirconia from 15-60 wt % yttrium oxide (Y₂O₃), or other rare additives such as gadolinium oxide (GdO), ceria oxide (CeO), and Yb₂O₃ in a zirconia matrix, may also be used as low K compositions. The low K compositions typically reduce thermal conductivity by about 20% compared to the standard partially stabilized 8 wt % Y₂O₃, and balance of zirconia. The ultra-low K materials offer reduction in thermal conductivity of >40%. The binding agent may include any material appropriate for the base material of seal structure 100.

A vertical adjustment system 190 may be provided to vertically adjust a position of various parts of BJ printer 126 to accommodate the addition of each new layer, e.g., a build platform 118 may lower and/or applicator 164 may rise after each layer. Vertical adjustment system 190 may include any now known or later developed linear actuators to provide such adjustment that are under the control of control system 122.

BJ system 120 may include machines from, for example, Desktop Metal, Digital Metal, ExOne, GE Additive, HP (known as Metal Jet Fusion), Viridis3D, and Voxeljet. Binder jetting services are also available from 3DEO, creator of a proprietary binder jetting technology (known as Intelligent Layering), as well as many of the suppliers not mentioned.

In operation, BJ system 120 forms a preliminary abradable seal structure 194 using a binder jetting process. Initially, build platform 118 with powder thereon is provided. Control system 122 controls BJ printer 126, and in particular, applicator 164 (e.g., linear actuator 174) and printhead 132, to sequentially deposit binding agent on build platform 118 to generate a preliminary seal structure(s) 194, according to embodiments of the disclosure. Printhead 132 dispenses binding agent (similar to an inkjet printer) in a manner to create the desired shape of abradable seal structure 100 at the particular layer being built. As will be described, preliminary abradable seal structure 194 may include a plurality of adjoining cells 102 (FIG. 6), as described herein. When a binder layer is complete, build platform 118 lowers, and applicator 164 spreads a fresh layer of powder across platform 118 and top of seal structure 100 being printed. As noted, various parts of BJ printer 122 may vertically move via vertical adjustment system 190 to accommodate the addition of each new layer, e.g., a build platform 118 may lower and/or applicator 164 may rise after each layer. Printhead 132 prints another layer and this process repeats until seal structure 100 is complete. Abradable seal structure 100 may include any of the metal or ceramic materials listed herein.

As shown in FIG. 6, plurality of adjoining cells 102 may have at least one honeycomb portion 200, each honeycomb portion 200 having a plurality of honeycomb cells 102, i.e., generally hexagonal cells.

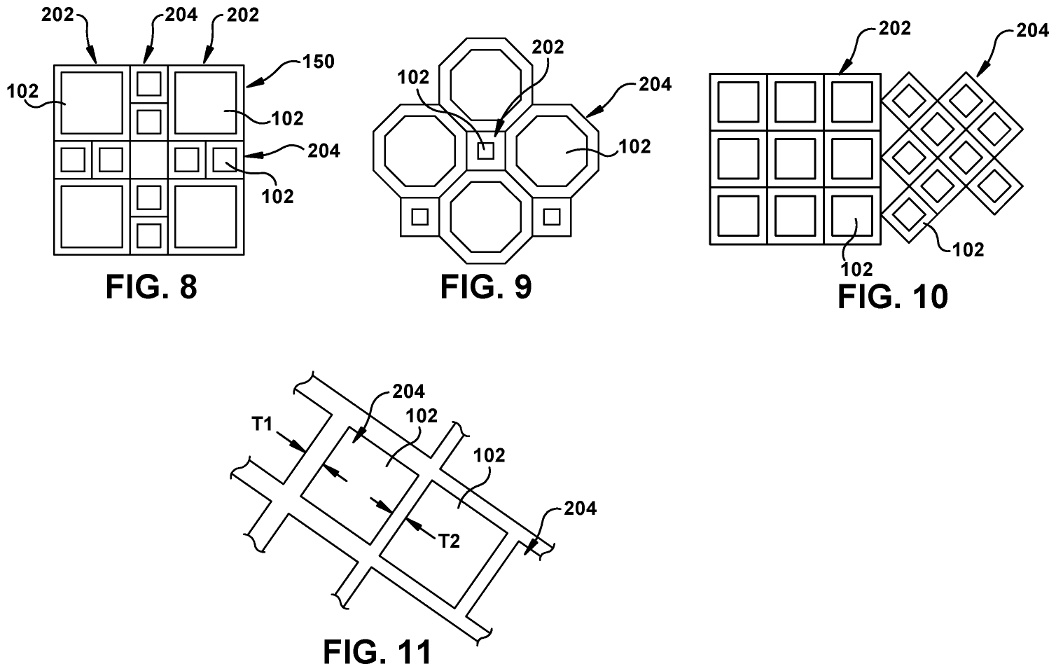

FIGS. 8-11 show plan views of various alternative embodiments achievable using methods according to embodiments of the disclosure. BJ system 102 allow formation of cells 102 with different size, different shape, and/or different configurations. To this end, plurality of adjoining cells 102 may include a first plurality of adjoining cells 202 and one or more second plurality of adjoining cells 204. FIG. 8 shows abradable seal structure 100 with pluralities of cells 202, 204 with different size. Here, cells 102 are rectangular/square but have pluralities with different size. While shown with a particular shaped cell, it is recognized that different sized cells 102 are possible regardless of shape or configuration. FIG. 9 shows abradable seal structure 100 with pluralities 202, 204 of different shaped cells, e.g., hexagonal and square. It is recognized that a wide variety of differently shaped cells may be possible. FIG. 10 shows abradable seal structure 100 with pluralities 202, 204 of different configurations of cells 102. “Configuration” means different orientations of the same shaped and sized cells, but it could include any other difference in arrangement. FIG. 11 shows abradable seal structure 100 with pluralities 202, 204 of different wall thicknesses of cells 102. Here, wall thickness T1 does not equal wall thickness T2. In non-limiting examples, cells sizes can vary from 3.12 millimeters (mm) to 9.52 mm, and wall thicknesses may vary between 0.15-0.28 mm. However, other ranges may be possible. It should be understood that first plurality of adjoining cells 202 may have more than one of a different size, different shape, different wall thickness, and different configuration of adjoining cells than second plurality of adjoining cells 204.

In addition to the above customizations, abradable seal structure 100 may have a varying porosity (or density) across an area thereof. For example, with reference to FIG. 8, plurality of cells 202 may have a different porosity than plurality of cells 204. With brief reference to FIG. 5, in one non-limiting example, cells that are expected to engage with seal rail 52 may have a different porosity than cells not expected to engage with seal rail 52. Alternatively, as shown in FIG. 6, where all cells 102 are identical in shape, abradable seal structure 100 may a first portion 210 with a first porosity and a second portion 212 with a second, different porosity. The porosity can also vary within abradable seal structure 100 at different radial positions thereof, e.g., different porosities at locations near inboard outer surface 104 and outboard outer surface 106. The porosity can be varied during the printing stage and/or during the sintering stage, described herein, of the processing. Additionally, sacrificial materials can be added to the powder, which burns out and leaves a porous structure. The size, shape and quantity of this sacrificial material can be varied to obtain the desired results.

In contrast to other additive manufacturing processes, once complete, preliminary seal structure 194 is sintered (or cured) in any appropriate fashion to form abradable seal structure 100. For example, preliminary seal structure 194 may be cured by placing it in a sintering furnace 196 to bond the powder material and burn away the binding agent. Sintering preliminary abradable seal structure 194 can be controlled to create a desired porosity of the abradable seal structure 100. More particularly, the sintering may be controlled to create a desired porosity, and other mechanical properties. For example, 50% porosity level could be better for cutting and wear of the blade tips. Un-sintered powder is, for example, 50% dense (50% filled with pores/air). As the powder is placed in furnace 196 and sintered, due to diffusion, the powder particles attach, thereby increasing density (lower porosity). This density (porosity level) can be tailored by changing the sintering temperature and duration. In one embodiment, abradable seal structure 100 may include a wall with at least one portion having a porosity between 1% and 50%. Preliminary seal structure 194 may be sintered while still encased in powder. In this latter case, the entire build platform 118 may be removed from the machine and loose powder blown away with compressed air in a controlled environment.

Typically, the sintering process results in an average surface roughness fine enough for many end-use parts and features without further processing. However, any additional processing such as sandblasting and polishing, can enhance the surface finish when necessary.

Embodiments of the disclosure also includes abradable seal structure 100 for gas turbine 10. The structure may include, as shown in FIGS. 6 and 8-11, a first plurality of adjoining cells 202 and a second plurality of adjoining cells 204. First plurality of adjoining cells 202 has at least one of a different size, shape, wall thickness and configuration of adjoining cells 102 than second plurality of adjoining cells 204. As noted, first and second plurality of adjoining cells 202, 204 are formed by binder jetting. In one embodiment, shown in FIG. 6, at least one first and second plurality of adjoining cells 202, 204 has at least one honeycomb portion (FIG. 6) with each honeycomb portion having a plurality of honeycomb cells. As noted, structure 100 may also have a varying porosity across an area thereof, i.e., porosity is different in different lateral locations of the structure. For example, as shown in FIG. 6, abradable seal structure 100 may have first portion 210 with a first porosity and second portion 212 with a second, different porosity.

Embodiments of the disclosure may also include gas turbine 10 (FIGS. 1-3) including abradable seal structure 100. Abradable seal structure 100 may be coupled to one of rotating structure, e.g., rotating blade 26, and a stationary structure 58 of gas turbine 10.

Embodiments of the disclosure provide abradable seal structure 100 for gas turbine 10. In contrast to conventional manufacturing processes, abradable seal structure 100 can be made of various materials, not necessarily weldable. Any of a variety of high temperature materials can be used. In addition, the porosity can be controlled during manufacture and tailored to provide different portions of the seal structure with different porosities. Abradable seal structure 100 can also have varying structure across its area, e.g., cell size, shape, wall thicknesses, cell configurations, etc. Hence, the binder jetting allows for a highly customized abradable seal member 100 not previously possible.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

1-8. (canceled)

9. An abradable seal structure for a gas turbine, the abradable seal structure comprising:
a body having a radial span, wherein a horizontal cross-section of the body at a selected radial position includes:
a first plurality of adjoining cells having a first porosity, and
a second plurality of adjoining cells horizontally adjacent the first plurality of adjoining cells and having a second porosity different than the first porosity,
wherein the first plurality of adjoining cells includes at least one of a different size, shape, wall thickness and configuration than the second plurality of adjoining cells,
wherein the first and second plurality of adjoining cells are formed by binder jetting.

10. (canceled)

11. The abradable seal structure of claim 9, wherein the abradable seal structure has a varying porosity across an area thereof.

12. (canceled)

13. The abradable seal structure of claim 9, wherein the abradable seal structure includes a metal selected from a group comprising: steel, stainless steel, nickel-based alloy, cobalt-based alloy and titanium-based alloy.

14. The abradable seal structure of claim 9, wherein the first plurality of adjoining cells and second plurality of adjoining cells each include a zirconia-based composition.

15. A gas turbine including the abradable seal structure of claim 9.

16. The gas turbine of claim 15, wherein the abradable seal structure is coupled to one of a rotating structure and a stationary structure of the gas turbine.

17. The abradable seal structure of claim 11, wherein the abradable seal structure includes a wall with at least one portion having a porosity between 1% and 50%.

18. (canceled)

19. An abradable seal structure for a gas turbine, the abradable seal structure comprising:
a first plurality of adjoining cells and a second plurality of adjoining cells, the first plurality of adjoining cells having at least one of a different size, shape, wall thickness and configuration of adjoining cells than the second plurality of adjoining cells,
wherein one of the first and second plurality of adjoining cells has at least one octagonal portion, and the other of the first and second plurality of adjoining cells has at least one square portion.
